(19) United States
(12) Patent Application Publication
(10) Pub. No.: US 2024/0397404 A1
(43) Pub. Date: Nov. 28, 2024

(54) METHODS AND APPARATUS FOR CONDITIONAL PSCELL ADDITION/CHANGE AND CONDITIONAL HANDOVER INTERWORKING AND RLF HANDLING

(71) Applicant: InterDigital Patent Holdings, Inc., Wilmington, DE (US)

(72) Inventors: Oumer Teyeb, Montreal (CA); Martino Freda, Laval (CA)

(21) Appl. No.: 18/696,295

(22) PCT Filed: Sep. 27, 2022
(86) PCT No.: PCT/US2022/044797

§ 371 Date: Mar. 27, 2024

Related U.S. Application Data
(60) Provisional application No. 63/249,198, filed on Sep. 28, 2021.

(51) Int. Cl. H04W 36/30; H04W 36/00

(52) U.S. Cl. CPC H04W 36/305; H04W 36/00835; H04W 36/304

(57) ABSTRACT

The disclosure pertains to methods and apparatus configured to receive, from a first base station, conditional primary secondary cell addition configuration information indicating one or more candidate primary secondary cells of a second base station, a detection of a radio link failure on a primary cell of the first base station and a signal quality threshold associated with the one or more candidate primary secondary cells; perform a primary secondary cell addition of a primary secondary cell based on a signal quality of the primary secondary cell and the signal quality threshold; send, to the second base station, first information comprising an indication of a completion of the primary secondary cell addition; and send, to the first base station using resources of the second base station, second information comprising an indication of the radio link failure on the primary cell of the first base station.

### CROSS-REFERENCE TO RELATED APPLICATIONS

This application claims the benefit of U.S. Patent Application No. 63/249,198, filed Sep. 28, 2021, which is incorporated herein by reference in its entirety.

### TECHNICAL FIELD

The disclosure pertains to methods and apparatus for interworking conditional Primary Secondary serving Cell (PSCell) addition/change (CPAC) with conditional handover (CHO) to effect efficient handling of radio link failure.

### BRIEF SUMMARY

Briefly stated, in one embodiment, a method implemented by a wireless transmit/receive unit (WTRU) includes receiving, from a first base station, conditional primary secondary cell addition configuration information indicating one or more candidate primary secondary cells of a second base station, a detection of a radio link failure on a primary cell of the first base station and a signal quality threshold associated with the one or more candidate primary secondary cells. Responsive to the detection of a radio link failure on the primary cell of the first base station, a primary secondary cell addition of a primary secondary cell of the one or more candidate primary secondary cells based on a signal quality of the primary secondary cell and the signal quality threshold is performed. First information comprising an indication of a completion of the primary secondary cell addition of the primary secondary cell of the one or more candidate primary secondary cells is sent to the second base station. Using resources of the second base station, second information comprising an indication of the radio link failure on the primary cell of the first base station is sent to the first base station.

In another embodiment, a Wireless Transmit/Receive Unit (WTRU) comprising a processor and a transmitter/receiver unit is configured to receive, from a first base station, conditional primary secondary cell addition configuration information indicating one or more candidate primary secondary cells of a second base station, a detection of a radio link failure on a primary cell of the first base station and a signal quality threshold associated with the one or more candidate primary secondary cells. Responsive to the detection of a radio link failure on the primary cell of the first base station, a primary secondary cell addition of a primary secondary cell of the one or more candidate primary secondary cells based on a signal quality of the primary secondary cell and the signal quality threshold is performed. First information comprising an indication of a completion of the primary secondary cell addition of the primary secondary cell of the one or more candidate primary secondary cells is sent to the second base station. Using resources of the second base station, second information comprising an indication of the radio link failure on the primary cell of the first base station is sent to the first base station.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal flow diagram illustrating an exemplary Rel-16 CHO configuration and process;

FIG. 3 is a flowchart illustrating an exemplary embodiment of radio link failure processing in accordance with an embodiment;

FIG. 4 is a flowchart illustrating a representative method of conditional PSCell addition implemented by a WTRU;

FIG. 5 is a flowchart illustrating a representative method of radio link failure processing implemented by a WTRU;

FIG. 6 is a flowchart illustrating a representative method of radio link failure processing implemented by a WTRU operating in a CONNECTED mode in Dual Connectivity (DC) with a master gNB and a secondary gNB; and

FIG. 7 is a flowchart illustrating a representative method of conditional PSCell change implemented by a WTRU.

### DETAILED DESCRIPTION

### 1. Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### 1.1 Example Networks for Implementation of the Embodiments

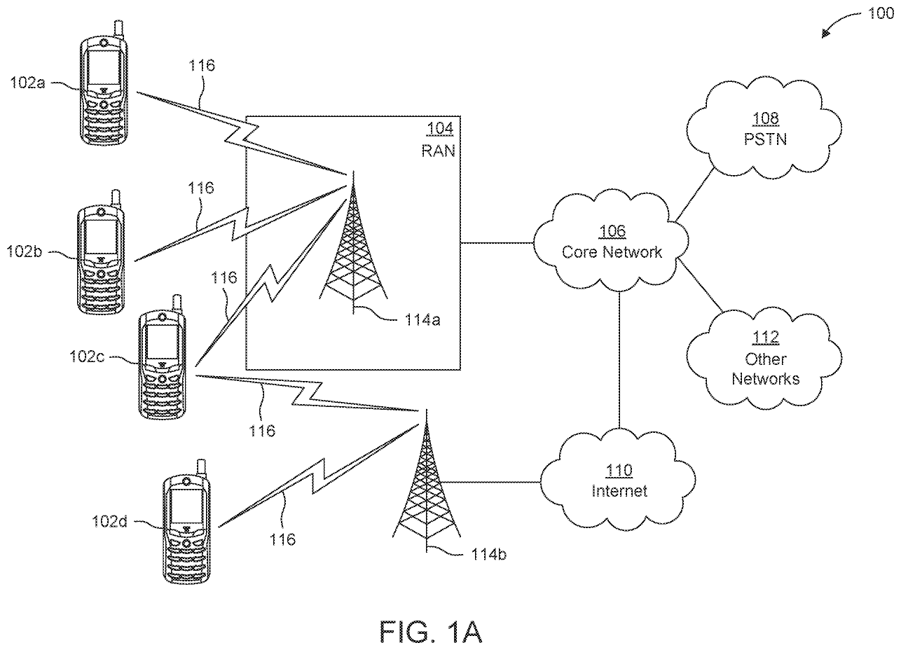

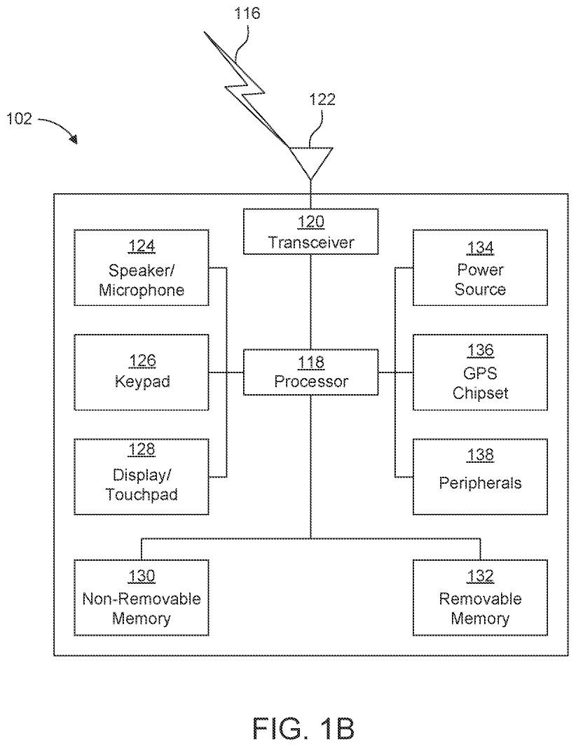

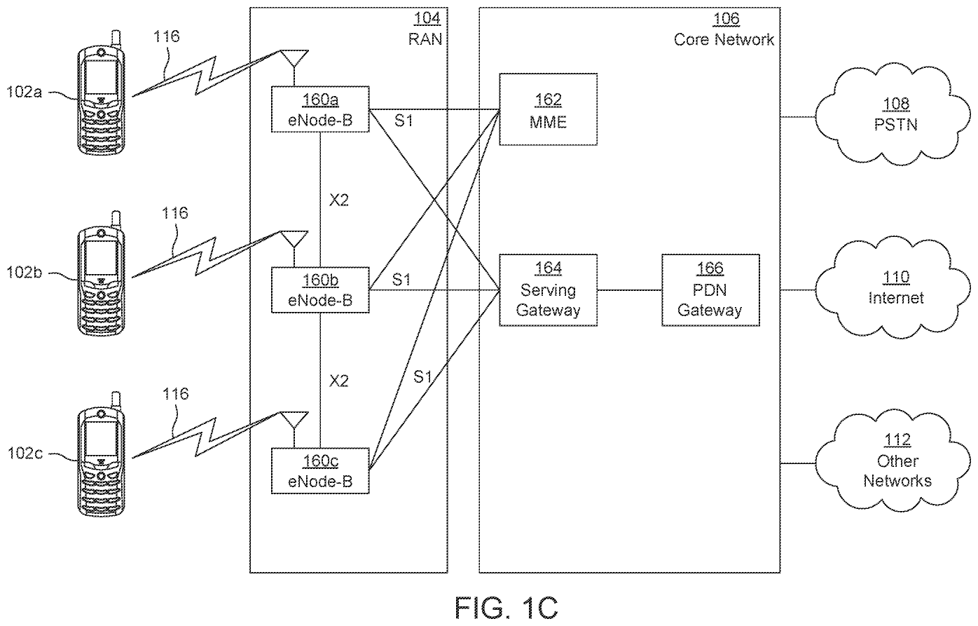

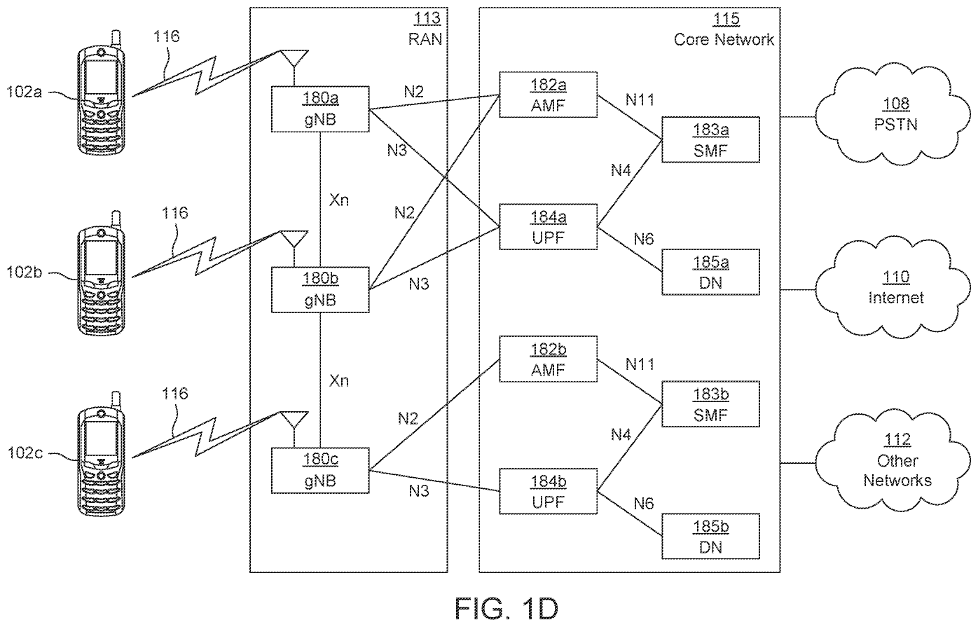

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. Byway of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11 ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 1.2 Conditional HO and CPAC in NR

3GPP Rel16 NR introduced the concept of conditional handover (CHO) and conditional PSCell Addition/Change (CPA/CPC, or collectively referred to as CPAC), with the main aim of reducing the likelihood of radio link failures (RLF) and handover failures (HOF).

Legacy LTE/NR handover is typically triggered by measurement reports, even though there is nothing preventing the network from sending a HO command to the WTRU even without receiving a measurement report. For example, the WTRU is configure with an A3 event that triggers a measurement report to be sent when the radio signal level/quality (RSRP, RSRQ, etc.) of a neighbor cell becomes better than the Primary serving cell (PCell) or also the Primary Secondary serving Cell (PSCell), in the case of Dual Connectivity (DC). The WTRU monitors the serving and neighbor cells and will send a measurement report when the conditions are fulfilled. When such a report is received, the network (current serving node/cell) will prepare the HO command (basically, an RRC Reconfiguration message, with a reconfigurationWithSync) and send it to the WTRU, which the WTRU executes immediately, resulting in the WTRU connecting to the target cell.

CHO differs from legacy handover in two main aspects, namely:
1) Multiple handover targets are prepared (as compared to only one target in the legacy case)
2) The WTRU does not immediately execute the CHO as in legacy handover. Instead, the WTRU is configured with a set of triggering conditions associated with the radio link quantity/quality, and the WTRU executes the handover towards one of the targets only when/if the triggering conditions are fulfilled.

The CHO command could be sent when the radio conditions toward the current serving cells are still favorable, thereby reducing the two main points of failure in legacy handover, e.g., failure to send the measurement report (e.g., if the link quality to the current serving cell falls below acceptable levels when the measurement reports are triggered in normal handover) and/or failure to receive the handover command (e.g., if the link quality to the current serving cell falls below acceptable levels after the WTRU has sent the measurement report, but before it has received the HO command).

The triggering conditions for a CHO could also be based on the radio quality of the serving cells and neighbor cells like the conditions that are used in legacy NR/LTE to trigger measurement reports. For example, the WTRU could be configured with a CHO that has A3-like triggering conditions and associated HO command. The WTRU monitors the current and serving cells, and, when the A3 triggering conditions are fulfilled, instead of sending a measurement report, it will execute the associated HO command and switch its connection towards the target cell.

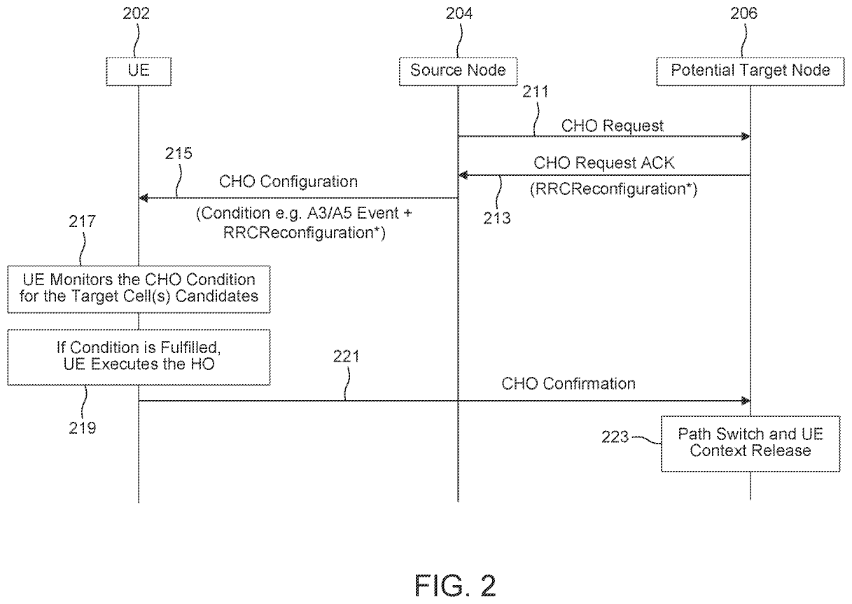

FIG. 2 is a signal flow diagram illustrating an exemplary Rel-16 CHO configuration and process. At 211, the source node 204 transmits a CHO request to the potential target node 206. In response, at 213, the target node 206 may send back a CHO request acknowledgement to the source node 204. In response to the acknowledgement 213, the source node 204 transmits a CHO configuration 215 to the WTRU 202. The CHO configuration may include the identity of the condition event, e.g., A3 or A5 and an RRCReconfiguration,

In response, as shown at 217, the WTRU 202 starts monitoring the CHO condition for the target cell candidate. If the condition is determined to have been fulfilled (such as shown at 219), the WTRU will execute the handover by transmitting a CHO confirmation to the target node 206 (such as shown at 232). Then, the path switch and WTRU context release can occur (223).

Another benefit of CHO is in helping prevent unnecessary re-establishments in case of a radio link failure. For example, a WTRU may be configured with multiple CHO targets and the WTRU experiences an RLF before the triggering conditions with any of the targets get fulfilled. Legacy operation would result in an RRC re-establishment procedure that would incur considerable interruption time for the bearers of the WTRU. However, in the case of CHO, if the WTRU, after detecting an RLF, ends up in a cell for which it has a CHO associated with it (e.g., the target cell is already prepared for it), the WTRU will execute the HO command associated with this target cell directly, instead of continuing with the full re-establishment procedure.

CPC and CPA are just extensions of CHO, but in DC scenarios. A WTRU could be configured with triggering conditions for PSCell change or addition, and when the triggering conditions are fulfilled, it will execute the associated PSCell change or PSCell add commands.

### 1.3 Measurements in NR

Measurement performed by the WTRU may be used by the network for mobility decisions (e.g., normal HO configuration, for determining/configuring CHO/CPAC, etc.).

For example, in RRC_CONNECTED, the WTRU may measure multiple beams (at least one) of a cell, and the measurement results (power values) may be averaged to derive the cell quality. The WTRU may be configured to consider a subset of the detected beams. Filtering may take place at two different levels: at the physical layer to derive beam quality and/or then at RRC level to derive cell quality from multiple beams. Cell quality from beam measurements may be derived in the same way for the serving cell(s) and/or for the non-serving cell(s). Measurement reports may contain the measurement results of the X best beams if the WTRU is configured to do so by the gNB, where X is an integer.

The measurement reporting configuration can be either event triggered or periodic. If it is periodic, the WTRU may send the measurement report every reporting interval (which can range between 120 ms and 30 min).

For event triggered measurements, the WTRU may send the measurement report when the conditions associated with the trigger event are fulfilled. The WTRU keeps measuring the radio link quality of the serving cell and neighbor cells and compares them with specified thresholds/offsets defined in the measurement reporting configuration. The measured radio link quality can be Reference Signal Received Power (RSRP), Reference Signal Received Quality (RSRQ), or Signal to Interference and Noise (SINR).

Any of the following measurement events are defined for NR:

### Intra-RAT Events:

Event A1 (Serving cell becomes better than threshold)
   Typically used to cancel an ongoing handover procedure. This may be used (e.g., required) if a WTRU moves toward cell edge and triggers a mobility procedure, but then subsequently moves back into good coverage before the mobility procedure has completed.
Event A2 (Serving cell becomes worse than threshold)
   Since it does not involve any neighbor cell measurements, A2 is typically used to trigger a blind mobility procedure, or the network may configure the WTRU for neighbor cell measurements when it receives a measurement report that is triggered due to event A2 in order to save WTRU battery (e.g., not perform neighbor cell measurement when the serving cell quality is good enough).
Event A3 (Neighbor cell becomes better than SpCell by a certain margin)
   Typically used for handover procedure. Note that an Spcell (special cell) is the primary serving cell of either the Master Cell Group (MCG), e.g., the PCell, or Secondary Cell Group (SCG), e.g., the PSCell. In DC operation, the Secondary Node (SN) can configure an A3 event for SN triggered PSCell change.
Event A4 (Neighbor becomes better than threshold)
   Typically used for handover procedures that do not depend upon the coverage of the serving cell (e.g., load balancing, where the WTRU is handed over to a good neighbor cell even if the serving cell conditions are excellent).
Event A5 (SpCell becomes worse than threshold1 and neighbor becomes better than threshold2)
   Like A3, this is typically used for handover, but unlike A3, it provides a handover triggering mechanism based upon absolute measurements of the serving and neighbor cell, whereas A3 uses relative comparison. As such, it is suitable for time critical handover when the serving cell becomes weak, and it is necessary to change toward another cell that may not satisfy the criteria for an event A3 handover.
Event A6 (Neighbor becomes offset better than Secondary Cell (SCell)):
   This is used for SCell addition/releasing.

### Inter-RAT Events:

Event B1 (Inter RAT neighbor becomes better than threshold)
   This is equivalent to A4, but for the case of inter-RAT handover.
Event B2 (PCell becomes worse than threshold1 and inter RAT neighbor becomes better than threshold2)
   This is equivalent to A5, but for the case of inter-RAT handover.

In rel-16, the events CondEvent A3 and CondEvent A5 were introduced for conditional handover execution triggering, where:
CondEventA3: Conditional reconfiguration candidate becomes amount of offset better than PCell/PSCell;
CondEvent A5: PCell/PSCell becomes worse than absolute threshold1 AND Conditional reconfiguration candidate becomes better than another absolute threshold2;
In rel-17, there has been discussions of extending the other events as well for CHO/CPAC. This includes CondEvent A4 (for CPA and MN initiated CPC) and CondEvent B1 (for inter-RAT CPA and MN initiated CPC in (NG)EN-DC).

### 2. Legacy CPAC and CHO Behaviours

### 2.1 WTRU in Single Connectivity Detects RLF

If a WTRU in single connectivity detects RLF, re-establishment is triggered, even though there may be a CPA configured.

Re-establishment causes considerable interruption to both the UL and DL transmission of the WTRU, as the WTRU has to go to IDLE mode, perform cell reselection, send a re-establishment request, and wait for a reconfiguration from the new target cell/node. On the network side, there could be further delays, especially where the WTRU is re-establishing to a cell belonging to a different gNB than the gNB that was controlling the cell where the failure occurred, as inter-node communication may be initiated to transfer the WTRU context from the source gNB to the target gNB.

Thus, avoiding re-establishment is very desirable, especially if the WTRU has active delay-intolerant bearers. In rel-16, there was one enhancement that was introduced regarding re-establishments by using CHO. If a WTRU detects an RLF while monitoring CHO triggering conditions and starts the re-establishment process by re-selects to a cell that belongs to one of the CHO targets, it will execute the CHO towards that target instead of proceeding the re-establishment. However, the usage of active CPA configuration to prevent re-establishment was not considered.

### 2.2 WTRU Detects RLF and Triggers Re-Establishment

A WTRU may detect RLF and trigger re-establishment, even though it has an SCG that is deactivated/suspended for power saving purposes.

In rel-17, Secondary Cell Group (SCG) deactivation/suspension is being introduced for WTRU power saving, where the WTRU suspends SCG transmission/reception (including PDCCH monitoring) for power saving purposes (e.g., when there is not enough data). Similar to the case of in section 2.1, it is undesirable to resort to re-establishment and incur considerable delay in the case of RLF detection while there is a properly functioning SCG that was deactivated just for power saving reasons.

2.3 CPAC Target when the Triggering Conditions are Fulfilled

The CPAC target may not be the best cell when the triggering conditions are fulfilled.

Rel-16 CPAC provides the network with a mechanism to prepare several target cells/nodes and let the WTRU perform PSCell addition (in the case of CPA) or PSCell change (in the case of CPC) to the target cell/node fulfilling the conditions when the triggering conditions are fulfilled. The more target cells that are prepared, the higher the likelihood that the WTRU will choose the best PSCell. However, preparing a multitude of target cells is resource intensive, as each target must reserve the resources required to accommodate the WTRU bearers that are associated with SCG resources, such as split bearers and SCG bearers, during the whole time that the WTRU is monitoring the CPAC triggering conditions. The network (e.g., must) makes a compromise and limits the number of CPA/CPC targets, depending on the load conditions at the moment.

Due to this practical limitation on the number of CPAC targets that can be prepared for a given WTRU, it is possible that, when the triggering conditions for a CPAC are fulfilled and the CPAC is executed, the target cell may not be the best PSCell for the WTRU at that time (e.g., there may be a better neighbor cell that the WTRU might have added as a PSCell), as the CPAC targets were likely chosen based on earlier measurement reports. Thus, the end result may be that the WTRU will execute the CPAC toward the target, and soon afterwards will send a measurement report indicating a better cell to the network (and the WTRU will be configured with a new PSCell). If this occurs frequently, it will not only increase the total signaling in the network, but could also degrade WTRU performance, as each PSCell change may incur a certain period of service interruption (e.g., for SCG bearers or split bearers with SCG as the primary path).

### 2.4 SCG Failure Information Report Triggering During S-RLF Detection

SCG failure information reporting may be triggered during S-RLF detection, even if there may be a good CPC target to fall back to.

If a WTRU detects an RLF on the PSCell (henceforth referred to as S-RLF) while monitoring CPC triggering conditions, it will suspend the SCG transmission and send an SCG Failure Information report to the MCG (and the MCG may either release the SCG or change it based on the included measurement report in the failure report). Since SCG transmission is suspended until the new SCG is configured, this will cause service interruption for bearers that are primarily using SCG resources (e.g., SCG bearers or split bearers with SCG as the primary path). This interruption time could be significant for a delay intolerant bearer, as it is equal to the sum of (1) the time to prepare the failure report, the time to send the report to the MCG (including an extra UL scheduling request/BSR delay, if the WTRU does not have active UL grants at that time) the time for the gNB to decide on the best SCG, the time to receive the SCG reconfiguration message, and the time to execute that message and perform RACH procedure (if required) to achieve UL sync with the new PSCell.

### 2.5 Rel-16 CPAC and CHO Configurations

In Rel-16, CPAC and CHO configurations are independent. Sometimes it may be preferrable to have relations between the CPAC and CHO configurations. For example, the network may prefer the WTRU to perform DC between co-located gNBs, or between a given pair of frequency bands, etc. Thus, it is possible for the WTRU to end up choosing the best CHO target and the best CPAC targets independently, but not getting the best performance.

2.6 Note about Integrated Access Backhaul (IAB) and Sidelink Relaying

The above problems may be detrimental in scenarios like Integrated Access Backhaul (IAB) or Sidelink relaying, where the IAB node or the sidelink relay is the entity that is involved in the RLF/S-RLF and it may be serving a multitude of WTRUs at that time (or even other IAB nodes or relays, in a multi-hop scenario). In these cases, there is a strong incentive to prevent the IAB node or relay node from performing re-establishments, as that may trigger a cascade of re-establishments of the WTRUs that are directly connected to the IAB node or relay, or even other nodes/relays/WTRUs further down the path in the case of multi-hop. Also, in the case of S-RLFs, the suspension of the SCG operation for a considerable time may drastically impact the performance of a multitude of WTRUs/bearers.

### 3. Methods and Apparatus for CPAC and CHO Enhancements

In the description below, unless otherwise specified, the term candidate cell is used to refer to a neighbor cell that is being measured by the WTRU and which also is one of the target cells in the CPAC/CHO configurations that the WTRU has received/stored.

In the description below, unless otherwise specified, the term non-candidate cell is used to refer to a neighbor cell that is being measured by the WTRU and which is not one of the target cells in the CHO/CPAC configurations that the WTRU has received/stored.

In the description below, the term WTRU is used to describe any wireless device that is communicating with a network infrastructure (either directly or via another wireless device) or with another wireless device. Some examples of this include a traditional mobile/smart phone, a laptop/computer with wireless connectivity, a sidelink WTRU acting as a WTRU-to-WTRU relay or WTRU-to-Network relay (e.g., over sidelink), an IAB node, etc.

In the description below, unless otherwise specified, RLF means RLF on the PCell. The term S-RLF is used to describe RLF of the PSCell.

### 3.1 WTRU in Single Connectivity Detects RLF

### CPA for Handling RLF or Near-RLF

In one embodiment, a WTRU in single connectivity may be provided with a CPA configuration that includes one or more criteria related to RLF detection on the PCell and one or more criteria related to a neighbor cell that is a candidate for a PSCell (e.g., signal level threshold in terms of the RSRP, RSRQ, or SINR (Signal to Interference and Noise Ratio) becomes above a certain threshold). The WTRU may perform radio link monitoring (RLM) on the PCell, and, based on some condition associated with RLM (e.g., detection of RLF on the PCell), it checks if the configured PSCell fulfills the configured conditions. If so, the WTRU will execute the associated CPA configuration, suspend MCG transmission, and/or send an MCG failure information report (that includes the latest measurements) to the network via the newly established SCG. If the candidate PSCell does not fulfill the configured condition, the WTRU will proceed with the legacy procedure of declaring RLF and/or performing re-establishment procedure.

Some advantages of this embodiment are:
It reduces the service interruption delay associated with the legacy way of performing re-establishment (e.g., no need to go to IDLE mode, perform cell re-selection, inter-node communication for WTRU context fetching etc.).
Using CPA for RLF recovery on the PCell does not incur considerable resource reservation at the network because the main resources that are used (e.g., needed) are just for Signaling Radio Bearers (SRBs) (e.g., for split SRB1/2 or SRB3) so that the WTRU could utilize the new SCG to send the MCG failure information report and also receive subsequent MCG reconfiguration. As such, the network could prepare several CPA targets for RLF recovery without consuming considerable network resources.
Since the WTRU does not need to operate in DC mode until it has detected RLF, the extra demand on the WTRU for this scheme (e.g., in terms of WTRU battery consumption for PDCCH monitoring on the SCG, RLM on the PSCell, etc.) are minimal.

In one embodiment, the CPA configuration may be dependent on the QoS (e.g., priority) of the active bearer types at the WTRU. For example, the WTRU may apply the CPA configuration on RLF only if it has bearers that have very strict delay constraints (e.g., URLLC bearers).

In one embodiment, further reduction of the service interruption delay may be achieved by changing the bearer type of some of the bearers (e.g., URLLC type bearers) to SCG or split bearers with SCG as the primary path when applying the CPA configuration. In this way, UL/DL data transmission may proceed while waiting for the network to reconfigure the MCG based on the MCG failure information report. The bearer type switching could be part of the CPA configuration, or it could be an autonomous behavior specified in 3GPP standards when executing a CPA based on RLF detection. It should be noted that this scheme may use (e.g., will require) more network resource utilization, as the target SCG may (e.g., has to) be prepared to accommodate the SRB(s) of the WTRU, but also some of the DRBs.

In one embodiment, additional flags may be introduced in the CPA configuration to indicate that this CPA is related to RLF recovery.

In one embodiment, once the MCG reconfiguration is received in response to an MCG failure report that is sent via a new SCG that was established due to an RLF, the WTRU releases the SCG after the successful execution of the received MCG reconfiguration.

In one embodiment, the WTRU will keep the CPA configuration for RLF recovery after releasing the SCG subsequent to MCG reconfiguration.

In one embodiment, instead of RLF of the PCell, the criteria associated with the CPA with regard to the PCell is a signal level threshold in terms of any of the RSRP/RSRQ/SINR of the PCell (e.g., it falls below a certain threshold). That is, when the signal level of the PCell falls below this configured threshold, the WTRU checks if the candidate PSCell has a signal level above the configured threshold for the cell, and, if so, it will execute the associated CPA configuration. This can be considered a pre-emptive scheme as compared to the RLF based CPA because SCG would be established before the WTRU experiences RLF, and, as such, normal MCG failure procedure could proceed if RLF occurs afterwards.

In one embodiment, instead of RLF of the PCell, the criteria associated with the CPA with regard to the PCell may be the number of consecutive Out of Sync (OOS) indications from the lower layers. The WTRU may initiate CPA prior to potential RLF being triggered so that the MCG Failure report can be sent with lower latency. In such embodiment, if an IS (In Sync) is detected from lower layers which resets the consecutive number of OOS indications maintained by the RRC layer, the WTRU may remove/drop the secondary cell.

In one embodiment, instead of RLF of the PCell, the criteria associated with the CPA with regard to the PCell may be based on beam failure reporting. The WTRU may initiate CPA upon beam failure on one of the MCG cells, for example. If beam failure is recovered, the WTRU may release the SCG added by the CPA. Otherwise, if RLF is triggered following this, the WTRU may send the MCG Failure to the added SCG.

In one embodiment, the CPA configuration may include both RLF and pre-RLF related configuration, with different thresholds. For example, the CPA configuration may include any of:
PSCell threshold_A for RLF cases.
PSCell threshold_B and PCell threshold_C for non-RLF cases (where, e.g., threshold_B>threshold_A, e.g., the requirements for the addition of the PSCell are less relaxed in the RLF case than in the non-RLF case).

In one embodiment, the CPA configuration may contain legacy CPA configurations as well. For example, any of:
PSCell threshold_A: for RLF cases.
PSCell threshold_B and PCell threshold_C for non-RLF cases (where, e.g., threshold_B>threshold_A, e.g., the requirements for the addition of the PSCell are less relaxed in the RLF case than in the non-RLF case).
PSCell threshold_D: for legacy CPA, e.g., add the PSCell if this threshold is fulfilled, regardless of the PCell level.

The WTRU may be configured with several CPA candidates, and several candidates may fulfill the CPA triggering conditions when RLF is detected (or when the PCell falls below a certain level in the non RLF case). In one embodiment, the WTRU may select the PSCell among the many that fulfill the conditions using any of the following:
Select the candidate with the best radio conditions.
Select one of the candidates randomly.
Leave it to WTRU implementation/preference.
The WTRU is provided with a priority list among the CPA candidates (e.g., explicit priority among each, priority based on other criteria such as operating frequency, etc.).

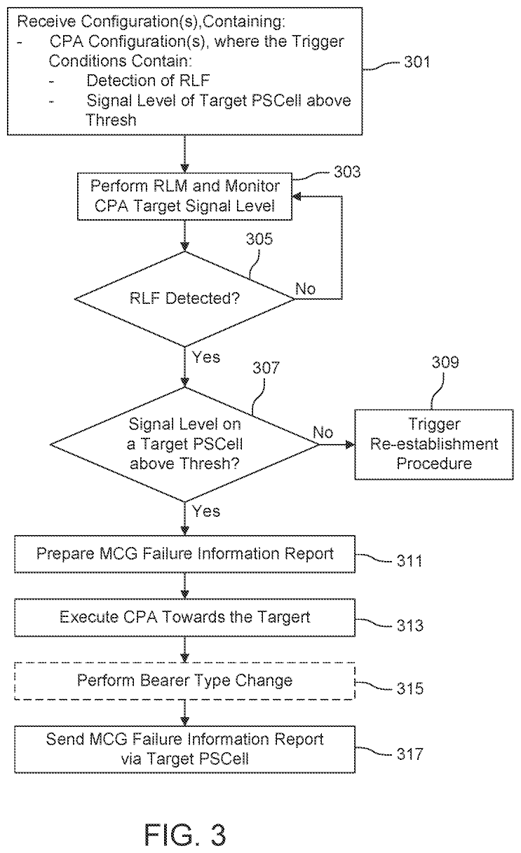

An example flowchart illustrating an exemplary embodiment in accordance with the principles described above is shown in FIG. 3. Initially, as shown at step 301, the WTRU may receive a configuration containing CPA configurations with trigger conditions, wherein the trigger conditions may include, for instance, detection of RLF and/or detection of a signal level of a target PSCell that is, for example, above a specified threshold.

In step 303, the WTRU may perform RLM and/or monitoring of the CPA target signal level. As shown in step 305, the WTRU may continue to monitor until it detects RLF. When it detects RLF, flow may proceed to step 307, where the WTRU determines if the signal level on any target PSCell is above a threshold. If not, flow may proceed to a trigger reestablishment procedure (step 309). If so, flow may instead proceed to steps 311, 313, 315, and 317. Specifically, the WTRU may prepare an MCG failure information report (step 311), execute a CPA toward the target PSCell (step 313), perform a bearer type change, as needed (step 315), and/or may send the MCG failure information report to the network via the target PSCell (step 317).

### 3.2 WTRU Detects RLF and Triggers Re-Establishment

In one embodiment, a WTRU in DC may be provided with an SCG activation configuration that includes one or more criteria related to RLF detection on the PCell. The WTRU performs RLM on the PCell, and, if it detects RLF on the PCell, it will activate the SCG and send an MCG failure information report via the SCG.

In one embodiment, the SCG activation configuration may be dependent on the QoS of the active bearer types at the WTRU. For example, the WTRU may apply the SCG activation on RLF (e.g., only) if it has bearers that have very strict delay constraints (e.g., URLLC bearers).

In one embodiment, further reduction of the service interruption delay may be achieved by changing the bearer type of some of the bearers (e.g., URLLC type bearers) to SCG or split bearers with SCG as the primary path when activating the SCG. UL/DL data transmission could proceed while waiting for the network to reconfigure the MCG based on the MCG failure information report. The bearer type switching could be part of the SCG activation configuration, or it can be an autonomous behavior specified in the 3GPP standards when activating an SCG based on RLF detection.

In one embodiment, if (e.g., once) the MCG reconfiguration is received in response to an MCG failure report that is sent via an SCG that is activated due to an RLF, the WTRU deactivates the SCG after the successful execution of the received MCG reconfiguration.

In one embodiment, instead of RLF of the PCell, the criteria associated with the SCG activation may be a signal level threshold in terms of the RSRP/RSRQ/SINR of the PCell (e.g., it falls below a certain threshold). That is, if (e.g., when) the signal level of the PCell falls below this configured threshold, the WTRU will perform SCG activation. This can be considered a pre-emptive scheme as compared to the RLF based SCG activation, because SCG would be activated before the WTRU experiences RLF, and, as such, normal MCG failure procedure could proceed if RLF occurs afterwards.

Without loss of generality, all conditions used in the previous embodiment for triggering CPA may be re-used for activation of a deactivated SCG. In cases where the WTRU is configured with two conditions (one for initiating CPA, and one for releasing the SCG due to not triggering RLF), the same conditions may be used for activating the SCG (and then deactivating it if RLF is not triggered on the MCG).

3.3 CPAC Target when the Triggering Conditions are Fulfilled
CPAC Trigger Conditions that Take Non-Candidate Cells into Consideration

In one embodiment, a WTRU may be provided with a CPAC configuration that includes additional criteria related to a non-candidate cell, and if (e.g., when) this condition is fulfilled, the WTRU may send a measurement report instead of executing the CPAC configuration.

In one embodiment, the WTRU may send the measurement report anytime the trigger conditions related to non-candidate cells are fulfilled.

In one embodiment, the WTRU may check the trigger conditions related to the sending of the measurement report if (e.g., only when) the trigger conditions related to the execution of the CPAC are fulfilled. That is, if (e.g., when) the CPAC conditions are fulfilled, the WTRU checks if the trigger conditions related to non-candidate cells are also fulfilled. If they are, a measurement report may be sent. If not, the CPAC may be executed as in legacy CPAC.

The additional criteria related to non-candidate cells may include any of the following:
An absolute radio condition of a non-candidate cell (e.g., RSRP/RSRQ/SINR of a non-candidate cell is above a certain threshold).
A relative radio condition of a non-candidate cell. The relative comparison could contain one or more of the following:
   a comparison with the serving PSCell (e.g., RSRP/RSRQ/SINR of a non-candidate cell is better than the current serving PSCell's RSRP/RSRQ/SINR by a certain threshold);
   a comparison with one of the candidate cells (e.g., RSRP/RSRQ/SINR of a non-candidate cell is better than a candidate cell's RSRP/RSRQ/SINR by a certain threshold).

Combinations of different relative and absolute conditions also are possible, for example:
RSRP/RSRQ/SINR of a non-candidate cell is above the current serving PSCell's RSRP/RSRQ/SINR by a first threshold or the RSRP/RSRQ/SINR of the non-candidate cell is above a candidate cell's RSRP/RSRQ/SINR by a second threshold;
RSRP/RSRQ/SINR of a non-candidate cell is above the current serving PSCell's RSRP/RSRQ/SINR by a first threshold and the RSRP/RSRQ/SINR of the non-candidate cell is above a candidate cell's RSRP/RSRQ/SINR by a second threshold;
RSRP/RSRQ/SINR of a non-candidate cell is above a first threshold or the RSRP/RSRQ/SINR of the non-candidate cell is above the serving PSCell's RSRP/RSRQ/SINR by a second threshold;
RSRP/RSRQ/SINR of a non-candidate cell is above a first threshold or the RSRP/RSRQ/SINR of the non-candidate cell is above a candidate cell's RSRP/RSRQ/SINR by a second threshold;
RSRP/RSRQ/SINR of a non-candidate cell is above a first threshold and the RSRP/RSRQ/SINR of the non-candidate cell is above the serving PSCell's RSRP/RSRQ/SINR by a second threshold;
RSRP/RSRQ/SINR of a non-candidate cell is above a first threshold and the RSRP/RSRQ/SINR of the non-candidate cell is above a candidate cell's RSRP/RSRQ/SINR by a second threshold.

In the above, the first and second thresholds may be the same or different.

In the above, the thresholds may be common for all CPAC configurations or specific to a given CPAC configuration.

In the above, the thresholds may be specific to a given candidate cell, common to all candidate cells, or common to a specific subset of the candidate cells.

In the above, the candidate cell to be compared with the non-candidate cell may be a specific candidate cell, any of the candidate cells, or all of the candidate cells. For example, in the last case (e.g., all candidate cells), this could mean that the non-candidate cell must have radio conditions better than all of the candidate cells by the second threshold.

In one embodiment, instead of a full measurement report, the WTRU may send just an indication that there is a better cell. This indication may also include the identity (e.g., PCI) of that cell.

### Configuration of Non-Candidate Cells

In one embodiment, a non-candidate cell may be considered any neighbor cell that the WTRU can measure/detect which is not a CPAC target cell.

In one embodiment, the WTRU may be explicitly configured regarding which cell(s) to consider as a non-candidate cell. For example:
the WTRU may be provided with a list of cells (e.g., list of PCIs) that it should consider as non-candidate cells
the WTRU may be provided with a list of cells (e.g., list of PCIs) that it should not consider as non-candidate cells
the WTRU may be provided with a list of frequencies; and only cells that are operating at the indicated frequencies may be considered as non-candidate cells
the WTRU may be provided with a list of frequencies, and only cells that are not operating at the indicated frequencies may be considered as non-candidate cells

In one embodiment, the CPAC configuration may include the information about the list of non-candidate cells.

In one embodiment, the list of non-candidate cells may be provided separately from the CPAC configuration (e.g., via a separate RRC Reconfiguration message, System information broadcast signaling, etc.).

In one embodiment, the list of non-candidate cells may be applicable to all CPAC configurations.

In one embodiment, the list of non-candidate cells may be specific to a given CPAC configuration.

In one embodiment, there may be a list of non-candidate cells that is applicable to all CPAC configurations, and there may be some other lists that are applicable only to specific CPAC configurations.

In the above embodiments, the conditions related to non-candidate cells may be applicable to all the non-candidate cells, or some conditions may be specific to the sub-set of the non-candidate cells. For example:
the WTRU may be configured with one (set of) threshold(s) related to non-candidate cells on frequency FR1 and another (set of) threshold(s) related to non-candidate cells on frequency FR2;
the WTRU may be configured with a list of candidate cells specific to each CPAC configuration, along with the (set of) threshold(s) related to those cells.
   Handling of the CPAC Configurations after the Measurement Reporting

In one embodiment, the WTRU may maintain all the CPAC configurations after the sending of the measurement report.

In one embodiment, the WTRU may release all the CPAC configurations after the sending of the measurement report.

In one embodiment, the WTRU may release the CPAC configuration related to the non-candidate cell that triggered the measurement report (in case the concerned non-candidate cell is specific to a specific CPAC configuration) but maintain all other CPAC configurations.

In one embodiment, the WTRU may maintain the CPAC configuration related to the non-candidate cell that triggered the measurement report (in case the concerned non-candidate cell is specific to a specific CPAC configuration) but release all the other CPAC configurations.

Conditions that Take Serving PSCell's Conditions into Consideration

In one embodiment, when the CPC was configured by the SCG, the sending of the measurement report may also be constrained by the current serving PSCell's radio condition. For example, the WTRU may be configured to send the measurement report only if the serving PSCell's RSRP/RSRQ/SINR is above a certain threshold. Such a constraint could prevent the WTRU from trying to send the measurement report to the source PSCell if the radio conditions of the source node are not good enough to do so (and, in which case, executing the CPAC may be the best decision, even though the target cell may not be the best cell at that point).

Sending the Measurement Report Along with the CPAC Complete Message Toward a Target

In one embodiment, a WTRU may be configured with a CPAC configuration that includes additional criteria that is dependent on the conditions of a non-candidate cell, and, when the CPAC triggering conditions are fulfilled, the WTRU will further check if the additional criteria are fulfilled. If so, the WTRU executes the CPAC and also sends a measurement report that includes the measurements related to the concerned non-candidate cells.

In one embodiment, instead of a full measurement report, the WTRU may send just an indication that there is a better cell. This indication may also include the identity (e.g., PCI) of that cell.

In one embodiment, the measurement report, or the indication that there is a better cell may be sent in a separate message after the CPAC complete message to the target.

In another embodiment, the measurement report, or the indication that there is a better cell may be included/embedded in the CPAC complete message to the target.

### 3.4 SCG Failure Information Report Triggering During S-RLF Detection

### Preventing Unnecessary SCG Failure Reporting and Suspension of SCG

In one embodiment, the WTRU may be configured with one or more additional criteria related to CPC target cells that is/are to be checked when the WTRU detects an S-RLF (or a failure during PSCell change). If the criteria is/are fulfilled, then the WTRU executes the CPC configuration associated with the target cell that fulfills the conditions, instead of performing SCG failure information reporting to the MCG and suspending the SCG transmission.

The additional criteria related to CPC target cells may include one or more of the following:
An absolute radio condition of the CPC target cell (e.g., if an S-RLF is detected and the RSRP/RSRQ/SINR of the CPC target cell is above a certain threshold, execute the associated CPC instead of performing SCG failure information reporting and SCG suspension).
A relative radio condition of the CPC target cell. The relative comparison may be one or more of the following:
   a comparison with other CPC target cells (e.g., RSRP/RSRQ/SINR of the CPC target cell is better than all other CPC targets by a certain threshold)
   a comparison with a neighbor cell (e.g., RSRP/RSRQ/SINR of the CPC target cell is not worse than the best neighbor cell by more than a certain threshold)
   a comparison with one of the non-candidate cells (e.g., RSRP/RSRQ/SINR of the CPC target cell is not worse than the best non-candidate cell by more than a certain threshold)

A combination of different relative and absolute conditions may be used. For example, the criteria could be the CPC target cell has an RSRP/RSRQ/SINR better than a first threshold, and the RSRP/RSRQ/SINR is not worse by more than a second threshold as compared to the best neighbor cell. The first and second thresholds may be the same or different.

In case multiple CPC target cells fulfill the condition to be checked during S-RLF, the WTRU may select the best one among these target cells or select one of them in a random fashion. Alternatively, the WTRU may be configured with which CPC targets to prioritize. This could be done in an explicit/individual way (e.g., target cell x has priority 1, target cell y has priority 2, etc.), or it could be done in a group/generic way (e.g., priority is given to target cells that operate in frequency FR1).

The additional criteria and associated threshold to be checked when an S-RLF is detected may be specific to each CPC configuration or candidate cell, or there could be one configuration applicable to all CPC configurations or candidate cells.

In one embodiment, additional flags may be introduced in the CPC configuration to indicate that this CPC is related to S-RLF recovery.

In one embodiment, the CPC configuration may include both S-RLF and non-S-RLF related configuration, with different thresholds. For example, the CPC configuration may include:
PSCell threshold_A: for S-RLF cases
PSCell threshold_B1 and candidate cell threshold_B2 for non-RLF cases (e.g., the legacy CPC threshold to compare candidate cell with the serving cell)

### 3.5 CPAC and CHO Configurations Interrelationship

In one embodiment, the WTRU is configured with relationship information between CHO and CPAC configurations (e.g., “for CHO target cell x1, only CPAC target cells a, b and c should be considered”). Thus, when the conditions for the CHO target x1 are fulfilled, the WTRU may check the conditions for the associated CPAC target cells a, b, and c. If one of them fulfills the conditions, it may also execute the CPAC toward that cell. If more than one CPAC target fulfills the conditions, the WTRU may choose one of them randomly, e.g., based on the one with the best radio conditions or based on some priority configuration.

In one embodiment, the WTRU may be configured with CHO and CPAC configurations that are associated with each other. The WTRU also may be configured to check both the CHO and CPAC configurations at the same time (e.g., “monitor CHO target cell x1, and CPAC target cells a, b and c together”). Thus, the WTRU will check the condition for the CHO target x1 as well as the CPAC targets and will execute the CHO and CPAC simultaneously only if both are fulfilled. If more than one CPAC target fulfills the conditions, the WTRU may choose one of them randomly, e.g., based on the one with the best radio conditions or based on some priority configuration.

In one embodiment, the CHO configuration may have two sets of thresholds, an independent one and another one associated with CPAC candidates. For example, if the conditions concerning the CHO target are excellent (e.g., above threshold1), the CHO may be executed whether the associated CPAC candidates fulfill the target. However, if the conditions concerning the CHO target are above threshold2 but below threshold1, then the CHO may be executed only if there is an associated CPAC candidate that fulfills the target.

In one embodiment, the WTRU may be configured with a CHO configuration that includes within it an MR-DC configuration, with a criteria associated with target PCell(s) and target PSCell(s). The WTRU may monitor both conditions simultaneously and will execute the CHO configuration when both the PCell and PSCell threshold are fulfilled.

### 4. Exemplary Embodiments

### Example 1: CPA for Handling RLF or Near-RLF

A WTRU that is operating in CONNECTED mode, in single connectivity with a gNB, does the following:
The WTRU is configured with a CPA configuration, where the CPA configuration may include a list of candidate PSCells and CPA trigger conditions, where the trigger condition may be one or more of the following:
   Detection of RLF on the PCell
   The signal level (e.g., RSRP/RSRQ/SINR, etc.) of the PCell dropping below a first configured threshold
   The signal level of the candidate PSCell being above a second configured threshold
Performing RLM and RRM on the PCell and monitoring the other CPA trigger conditions
On detecting an RLF or the signal level of the PCell dropping below the first threshold
   If the signal level of a candidate PSCell is above the second threshold
      Considering the conditions for CPA to be fulfilled
      If the CPA was triggered due to an RLF
         Refraining from performing/triggering the re-establishment procedure
         Preparing an MCG failure information report
      Executing the associated CPA configuration
      If the CPA was triggered due to an RLF
         Sending the MCG failure information via the newly added PSCell (e.g., embedded within the CPA reconfiguration complete message or in a separate message).
   If the signal level of a candidate PSCell is not above the second threshold
      Performing re-establishment.

### Example 2: SCG Activation for Handling RLF or Near-RLF

A WTRU that is operating in CONNECTED mode, in DC with a master gNB and secondary gNB, with the SCG deactivated, does the following:
The WTRU is configured with an SCG activation configuration, where the activation depends on one or more of the following trigger conditions:
   Detection of RLF on the PCell
   The signal level (e.g., RSRP/RSRQ/SINR, etc.) of the PCell dropping below a first configured threshold
   The signal level of the deactivated PSCell being above a second configured threshold
Performing RLM and RRM on the PCell, and monitoring the SCG activation trigger conditions
On detecting an RLF or the signal level of the PCell dropping below the first threshold
   If the signal level of the PSCell is above the second threshold
      Considering the SCG activation conditions to be fulfilled
      If the SCG activation was triggered due to an RLF
         Refraining from performing/triggering the re-establishment procedure
         Preparing an MCG failure information report
      Activating the SCG
      If the SCG activation was triggered due to an RLF
         Sending the MCG failure information via the newly activated SCG (e.g. either as part of the SCG activation procedure, or in a separate message after the SCG is activated).
   If the signal level of a candidate PSCell is not above the second threshold
      Performing re-establishment.

### Example 3a: Sending Measurements Instead of or Along with CPA Execution

A WTRU that is operating in CONNECTED mode, in single connectivity with a gNB, does the following:
The WTRU is configured with a CPA configuration that includes a set of candidate PSCells
The WTRU is configured to measure a list of cells that may not belong to the CPA candidate cells
The WTRU is configured with measurement configuration with trigger conditions that are related to non-candidate cells (e.g., absolute radio signal levels, relative signal levels as compared to CPA candidate cells, etc.)
The WTRU monitors the CPA trigger conditions
If the CPC trigger conditions are fulfilled, the WTRU checks to see if the measurement trigger conditions are fulfilled for any of the non-candidate cells
   If the measurement trigger conditions are not fulfilled, the WTRU executes the CPA toward the candidate cell that fulfilled the trigger conditions
   If the measurement trigger conditions are fulfilled for a non-candidate cell, the WTRU does one of the following
      The WTRU refrains from executing the CPA and sends the measurement report to the network
      The WTRU executes the CPA and includes the measurement report in the complete message.

### Example 3b: Sending Measurements Instead of or Along with CPC Execution

A WTRU that is operating in CONNECTED mode, in DC with a master gNB and secondary gNB, does the following:
The WTRU is configured with a CPC configuration that includes a set of candidate PSCells
The WTRU is configured to measure a list of cells that may not belong to the CPC candidate cells
The WTRU is configured with measurement configuration with trigger conditions that are related to non-candidate cells (e.g., absolute radio signal levels, relative signal levels as compared to the serving PSCell, relative signal levels as compared to CPC candidate cells, relative signal levels as compared to CPC candidate cells and serving PSCell, etc.)
If the CPC was configured by the SCG, the WTRU is also configured with a threshold related to the serving PSCell, indicating eligibility for sending measuring reports
The WTRU monitors the CPC trigger conditions
If the CPC trigger conditions are fulfilled, the WTRU checks to see if the measurement trigger conditions are fulfilled for any of the non-candidate cells
   If the measurement trigger conditions are not fulfilled or they are, but (for the case CPC was configured by the SCG) the serving PSCell does not fulfill the measurement reporting eligibility threshold, the WTRU executes the CPC toward the candidate cell that fulfilled the trigger conditions
   If the measurement trigger conditions are fulfilled for a non-candidate cell
      For the case of CPC configured by the MCG or
      For the case of CPC configured by the SCG and the serving PSCell fulfills the measurement reporting eligibility threshold, the WTRU does one of the following:
         The WTRU refrains from executing the CPC and sends the measurement report to the network (to the MCG or SCG, depending which one configured the CPC)
         The WTRU executes the CPC and includes the measurement report in the complete message.

### Example 4: CPC Based on S-RLF

A WTRU that is operating in CONNECTED mode, in DC with a master gNB and secondary gNB, does the following:
The WTRU is configured with a Conditional PSCell Change (CPC) configuration, where the CPC configuration may include a list of candidate PSCells and CPC trigger conditions, where the trigger condition may contain one or more of the following:
   Detection of RLF on the PSCell
   A signal level threshold (e.g., RSRP/RSRQ/SINR, etc.) of the candidate PSCell
Performing S-RLM and monitoring the signal level threshold on the candidate PSCells
On detecting S-RLF
   Preparing an SCG failure information report
   If one of the target PSCells fulfills the configured CPC signal level threshold
      Executing the associated CPC configuration
      Sending the SCG failure information via the newly added PSCell (e.g. after or embedded within the CPC reconfiguration complete message to the PSCell).

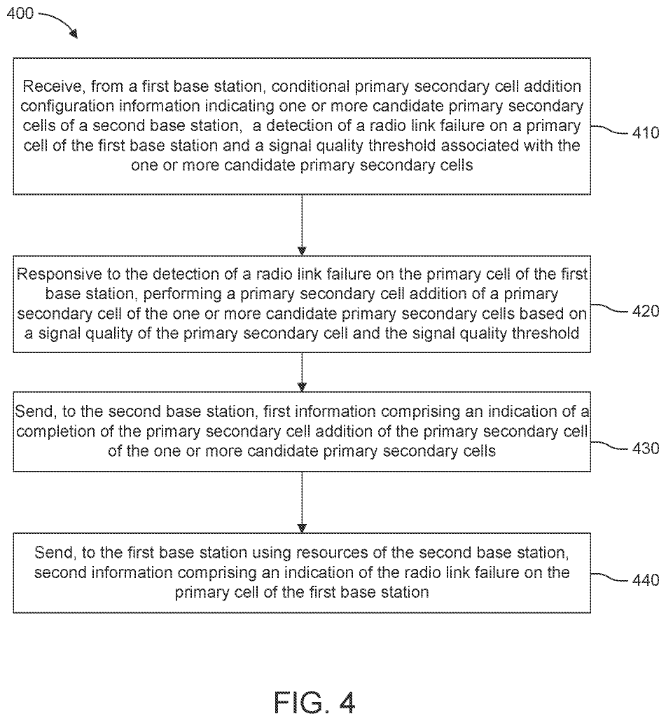

FIG. 4 is a flowchart illustrating a representative method implemented by a WTRU 102.

Referring to FIG. 4, the representative method 400 may include, at block 410, receiving, from a first base station, conditional primary secondary cell addition configuration information indicating one or more candidate primary secondary cells of a second base station, a detection of a radio link failure on a primary cell of the first base station and a signal quality threshold associated with the one or more candidate primary secondary cells. At block 420, responsive to the detection of a radio link failure on the primary cell of the first base station, the WTRU may perform a primary secondary cell addition of a primary secondary cell of the one or more candidate primary secondary cells based on a signal quality of the primary secondary cell and the signal quality threshold. At block 430, the WTRU may send, to the second base station, first information comprising an indication of a completion of the primary secondary cell addition of the primary secondary cell of the one or more candidate primary secondary cells. At block 440, the WTRU may send, to the first base station, using resources of the second base station, second information comprising an indication of the radio link failure on the primary cell of the first base station.

In certain representative embodiments, the second information may further comprise the signal quality of the primary secondary cell.

In certain representative embodiments, the second information may further comprise the signal quality of a neighbor cell of the WTRU and/or a serving cell of the WTRU.

In certain representative embodiments, the signal quality threshold may comprise any of: a reference signal received power threshold, a reference signal received quality threshold, and signal to interference and noise threshold.

In certain representative embodiments, the method 400 may further comprise: performing bearer type change.

In certain representative embodiments, the WTRU may initially operate in a connected mode in single connectivity.

In certain representative embodiments, the method 400 may further comprise: selecting the primary secondary cell among a subset of the one or more candidate primary secondary cells, wherein each primary secondary cell of the subset of the one or more candidate primary secondary cells has a signal quality above the signal quality threshold.

In certain representative embodiments, selecting the primary secondary cell may be based on a priority associated with each primary secondary cell of the subset of the one or more candidate primary secondary cells and/or the signal quality of each primary secondary cell of the subset of the one or more candidate primary secondary cells

In certain representative embodiments, the first base station may be associated with a master cell group and further comprising: receiving, from the second base station, third information indicating a master cell group reconfiguration.

In certain representative embodiments, the method 400 may further comprise: applying a master cell group reconfiguration using the third information indicating a master cell group reconfiguration and/or releasing the resources of the second base station.

In certain representative embodiments, the second information may be included in a master cell group failure information report.

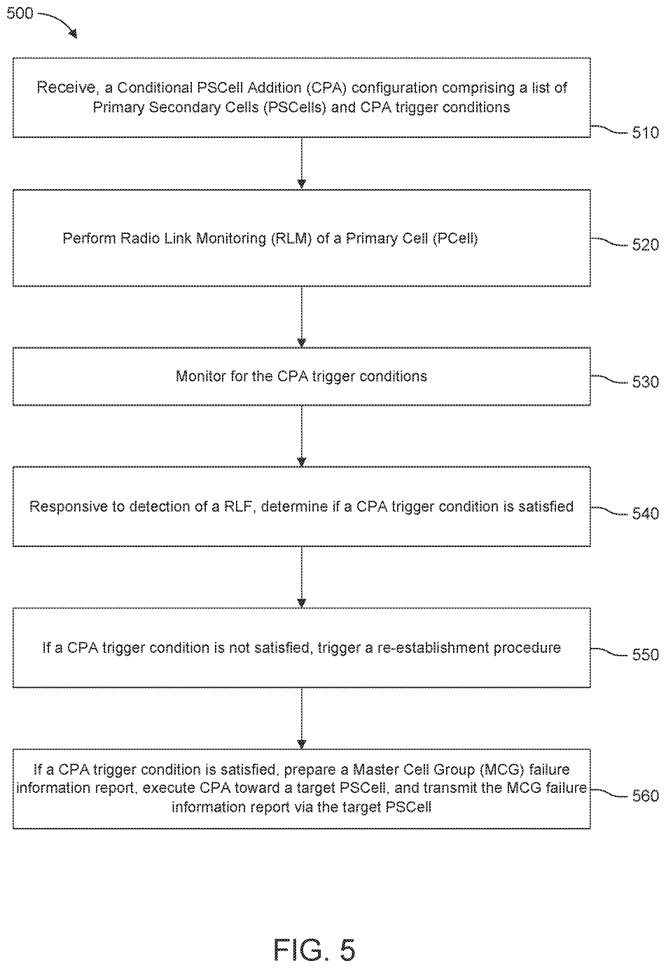

FIG. 5 is a flowchart illustrating a representative method implemented by a WTRU 102.

Referring to FIG. 5, the representative method 500 may include, at block 510, receiving a CPA configuration comprising a list of PSCells and CPA trigger conditions. At block 520, the WTRU may perform RLM of a PCell. At block 530, the WTRU may monitor for the CPA trigger conditions. At block 540, the WTRU may, responsive to detection of a RLF, determine if a CPA trigger condition is satisfied. At block 550, if a CPA trigger condition is not satisfied, the WTRU may trigger a re-establishment procedure. At block 560, if a CPA trigger condition is satisfied, the WTRU may prepare an MCG failure information report, execute CPA toward a target PSCell, and/or transmit the MCG failure information report via the target PSCell.

In certain representative embodiments, the CPA trigger condition comprises a signal level of a PSCell being above a threshold.

In certain representative embodiments, if a CPA trigger condition is satisfied, the representative method 500 may further comprise, performing bearer type change.

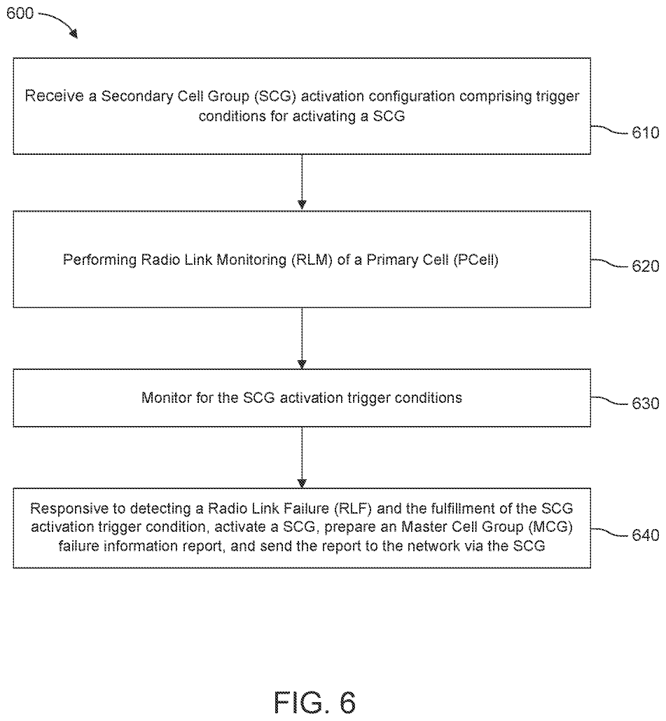

FIG. 6 is a flowchart illustrating a representative method implemented by a WTRU 102 operating in a CONNECTED mode in DC with a master gNB and a secondary gNB.

Referring to FIG. 6, the representative method 600 may include, at block 610, receiving a SCG activation configuration comprising trigger conditions for activating a SCG. At block 620, the WTRU may perform RLM of a PCell. At block 630, the WTRU may monitor for the SCG activation trigger conditions. At block 640, responsive to detecting a Radio Link Failure (RLF) and the fulfillment of the SCG activation trigger condition, the WTRU may activate a SCG, prepare an MCG failure information report, and/or send the report to the network via the SCG.

In certain representative embodiments, the SCG activation trigger condition may comprise a signal level of a PSCell being above a threshold.

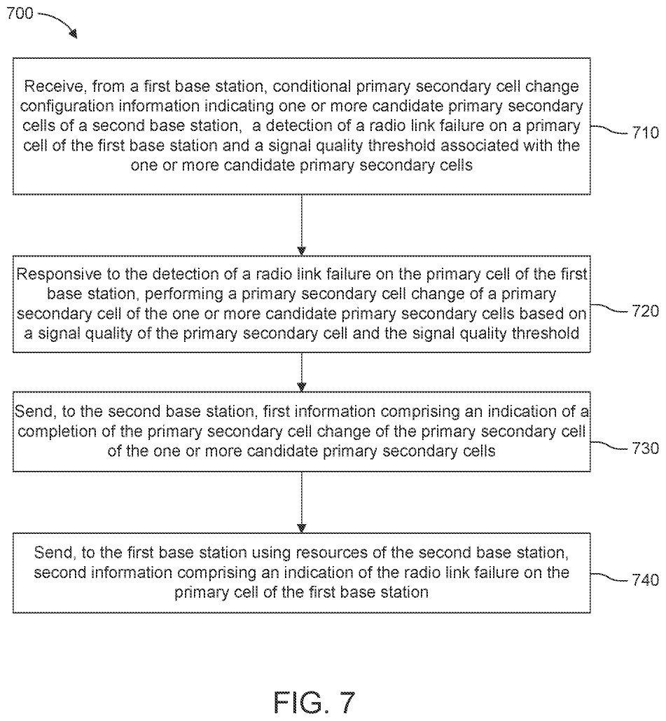

FIG. 7 is a flowchart illustrating a representative method implemented by a WTRU 102.

Referring to FIG. 7, the representative method 700 may include, at block 710, receiving, from a first base station, conditional primary secondary cell change configuration information indicating one or more candidate primary secondary cells of a second base station, a detection of a radio link failure on a primary cell of the first base station and a signal quality threshold associated with the one or more candidate primary secondary cells. At block 720, responsive to the detection of a radio link failure on the primary cell of the first base station, the WTRU may perform a primary secondary cell change of a primary secondary cell of the one or more candidate primary secondary cells based on a signal quality of the primary secondary cell and the signal quality threshold. At block 730, the WTRU may send, to the second base station, first information comprising an indication of a completion of the primary secondary cell change of the primary secondary cell of the one or more candidate primary secondary cells. At block 740, the WTRU may send, to the first base station, using resources of the second base station, second information comprising an indication of the radio link failure on the primary cell of the first base station.

In certain representative embodiments, the second information may further comprise the signal quality of the primary secondary cell.

In certain representative embodiments, the signal quality threshold may comprise any of: a reference signal received power threshold, a reference signal received quality threshold, and signal to interference and noise threshold.

In certain representative embodiments, the WTRU may initially operate in a connected mode in dual connectivity, for example, with a master gNB and secondary gNB.

In certain representative embodiments, the method 700 may further comprise: selecting the primary secondary cell among a subset of the one or more candidate primary secondary cells, wherein each primary secondary cell of the subset of the one or more candidate primary secondary cells has a signal quality above the signal quality threshold.

In certain representative embodiments, selecting the primary secondary cell may be based on a priority associated with each primary secondary cell of the subset of the one or more candidate primary secondary cells and/or the signal quality of each primary secondary cell of the subset of the one or more candidate primary secondary cells

In certain representative embodiments, the first base station may be associated with a master cell group and further comprising: receiving, from the second base station, third information indicating a master cell group reconfiguration.

In certain representative embodiments, the method 700 may further comprise: applying a master cell group reconfiguration using the third information indicating a master cell group reconfiguration and/or releasing the resources of the second base station.

In certain representative embodiments, the second information may be included in a master cell group failure information report.

### 5. Conclusion

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein, are provided below with respect to FIGS. 1A-1E.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. § 112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented by a wireless transmit/receive unit (WTRU), the method comprising:
receiving, from a first base station, configuration information indicating one or more candidate primary secondary cells of a second base station, detection information indicating a detection of a radio link failure on a primary cell of the first base station, a first signal quality threshold associated with the primary cell of the first base station and a second signal quality threshold associated with the one or more candidate primary secondary cells;
responsive to the detection information and based on a first signal quality of the primary cell of the first base station and the first signal quality threshold, performing a primary secondary cell addition of a primary secondary cell of the one or more candidate primary secondary cells based on a second signal quality of the primary secondary cell and the second signal quality threshold;
sending, to the second base station, first information comprising an indication of a completion of the primary secondary cell addition of the primary secondary cell of the one or more candidate primary secondary cells; and
sending, to the first base station using resources of the second base station, second information comprising an indication of the radio link failure on the primary cell of the first base station.

2. The method according to claim 1, wherein the second information further comprises any of: (1) a third signal quality of a neighbour cell of the WTRU and/or a serving cell of the WTRU, and (2) the second signal quality of the primary secondary cell.

3. The method according to claim 1, wherein any of the first signal quality threshold and the second signal quality threshold comprises any of a reference signal received power threshold, a reference signal received quality threshold, and signal to interference and noise threshold.

4. The method according to claim 1, further comprising:
performing bearer type change.

5. The method according to claim 1, wherein the WTRU is initially operating in a connected mode in single connectivity.

6. The method according to claim 1, further comprising:
selecting the primary secondary cell from among a subset of the one or more candidate primary secondary cells, wherein each candidate primary secondary cell of the subset of the one or more candidate primary secondary cells has a signal quality above the second signal quality threshold.

7. The method according to claim 6, wherein selecting the primary secondary cell is based on at least one of a priority associated with each candidate primary secondary cell of the subset of the one or more candidate primary secondary cells and the signal quality of each primary secondary cell of the subset of the one or more candidate primary secondary cells.

8. The method according to claim 1, wherein the first base station is associated with a master cell group, and the method further comprising receiving, from the second base station, third information indicating a master cell group reconfiguration.

9. The method according to claim 8, further comprising:
applying the master cell group reconfiguration.

10. The method according to claim 1, wherein the second information is included in a master cell group failure information report.

11. A wireless transmit/receive unit (WTRU) comprising a processor and a transmitter/receiver unit configured to:
receive, from a first base station, configuration information indicating one or more candidate primary secondary cells of a second base station, detection information indicating a detection of a radio link failure on a primary cell of the first base station, a first signal quality threshold associated with the primary cell of the first base station and a second signal quality threshold associated with the one or more candidate primary secondary cells;
responsive to the detection information and based on a first signal quality of the primary cell of the first base station and the first signal quality threshold, perform a primary secondary cell addition of a primary secondary cell of the one or more candidate primary secondary cells based on a second signal quality of the primary secondary cell and the second signal quality threshold;
send, to the second base station, first information comprising an indication of a completion of the primary secondary cell addition of the primary secondary cell of the one or more candidate primary secondary cells; and
send, to the first base station using resources of the second base station, second information comprising an indication of the radio link failure on the primary cell of the first base station.

12. The WTRU according to claim 11, wherein the second information further comprises any of: (1) a third signal quality of a neighbour cell of the WTRU and/or a serving cell of the WTRU, and (2) the second signal quality of the primary secondary cell.

13. The WTRU according to claim 11, wherein any of the first signal quality threshold and the second signal quality threshold comprises any of a reference signal received power threshold, a reference signal received quality threshold, and signal to interference and noise threshold.

14. The WTRU according to claim 11, wherein the processor is further configured to:
perform bearer type change.

15. The WTRU according to claim 11, wherein the WTRU operates initially in a connected mode in single connectivity.

16. The WTRU according to claim 11, wherein the processor is further configured to:
select the primary secondary cell from among a subset of the one or more candidate primary secondary cells, wherein each candidate primary secondary cell of the subset of the one or more candidate primary secondary cells has a signal quality above the second signal quality threshold.

17. The WTRU according to claim 16, wherein the primary secondary cell selection is based on at least one of a priority associated with each candidate primary secondary cell of the subset of the one or more candidate primary secondary cells and the signal quality of each candidate primary secondary cell of the subset of the one or more candidate primary secondary cells.

18. The WTRU according to claim 11, wherein the first base station is associated with a master cell group, and wherein the transmitter/receiver unit is further configured to receive, from the second base station, third information indicating a master cell group reconfiguration.

19. The WTRU according to claim 18, wherein the processor is further configured to:
apply the master cell group reconfiguration.

20. The WTRU according to claim 11, wherein the second information is included in a master cell group failure information report.
